(19) United States
(12) Patent Application Publication
(10) Pub. No.: US 2014/0081650 A1
(43) Pub. Date: Mar. 20, 2014

(54) SYSTEMS AND METHODS FOR DELIVERING ANALYSIS TOOLS IN A CLINICAL PRACTICE

(71) Applicant: Gary Sachs, Lincoln, MA (US)

(72) Inventor: Gary Sachs, Lincoln, MA (US)

(21) Appl. No.: 14/021,328

(22) Filed: Sep. 9, 2013

Related U.S. Application Data
(60) Provisional application No. 61/698,193, filed on Sep. 7, 2012.
(60) Provisional application No. 61/706,353, filed on Sep. 27, 2012.

(51) Int. Cl. G06F 19/00

(52) U.S. Cl. CPC G06F 19/366
USPC 705/2

(57) ABSTRACT

Provided are systems and methods for capturing and analyzing medical information. In one embodiment, the system includes an interface component configured to accept user responses to medical survey questions, a transformation component configured to transform survey responses associated with a plurality of analysis metrics into a common scale, an evaluation component configured to evaluate the survey responses from the plurality of analysis metrics against a predefined diagnostic threshold, and a display component configured to generate a summary view. Further provided are evidence-based systems and methods that facilitate collection and appreciation of patient information. The systems and methods include any one or more of: (1) shifting routine information collection outside the visit; (2) providing an intuitive system with minimal training requirements; (3) delivering high quality inputs to prepare and inform clinical decision makers; and (4) minimizing information overload, for example, by automatically identifying clinical indicators most relevant to potential issues.

### RELATED APPLICATIONS

This application claims priority under 35 U.S.C. §119(e) to U.S. Provisional Application Ser. No. 61/698,193 entitled “SYSTEMS AND METHODS FOR DELIVERING ANALYSIS TOOLS IN A CLINICAL PRACTICE” filed on Sep. 7, 2012, and U.S. Provisional Application Ser. No. 61/706,353, entitled “SYSTEMS AND METHODS FOR DELIVERING ANALYSIS TOOLS IN A CLINICAL PRACTICE” filed on Sep. 27, 2012 which applications are incorporated herein by reference in its entirety.

### BACKGROUND

Traditionally, the collection, processing and analysis of patient data in a clinical setting has been a paper-based process involving the dissemination of forms to patients, clinicians and payers where the completion of those forms is performed manually and possibly followed by further manual transcription into electronic format. The completion of self-reporting forms, such as the example waiting room form 100 shown in FIG. 1, and the example clinical monitoring form 102, have been time consuming and error-prone processes that detract from the overall quality of care received by a patient.

Often the time spent completing documentation during a patient's visit can subtract a substantial amount from the allotted time a clinician has available for interacting with the patient during an office visit. Without linked access to evidence-based treatments that can be immediately correlated with a patient's history and current condition, the time needed to properly diagnose and treat a patient increases as well.

### SUMMARY

Although patients, clinicians and payers frequently see references to collaborative evidence-based care as a desired solution to the frustrations and inefficiencies encountered in medical practice, it is realized that evidence-based care is largely unavailable in routine practice and a need exists for analysis systems that address current problems while providing automatic evidence-based clinical assistance. It is further realized, information continuity between visits, as well as incorporation of evidence-based diagnoses and treatments that draw information from a wide population are difficult to incorporate into traditional patient record keeping mechanisms.

An analysis system is provided to address any one or more of the following practitioner perceptions: (1) time required for measurement alone exceeds time allotted for visit; (2) lack of practical knowledge regarding implementation in practice; (3) belief that patients are not interested or up to the task; and (4) belief that clinicians don't care enough to do the job.

According to some aspects, evidence-based analysis systems are provided to facilitate collection and appreciation of patient information in daily care activity. In some implementations, an analysis system provides for any one or more of: (1) shifting routine information collection outside the visit (aligning burden with stakeholder interests); (2) providing an intuitive system with minimal training requirements; (3) delivering high quality inputs to prepare and inform clinical decision makers (support rather than replace the application of clinical judgment); and (4) minimizing information overload, by automatically identifying clinical indicators most relevant to potential issues.

Conventional systems rely on collecting patient information in a clinical setting, including collecting information in the waiting room, and further can rely on paper based organization of clinical notes. Various embodiments of evidence based analysis systems implement system components for collecting similar information, and can be further configured to apply additional formal scales to any patient information entered into the system. For example, patients can input information at home via a web connected device. Further embodiments can include components for automatic note generation to resolve conventional issues with clinician generated notes.

In one embodiment, the patient entered information is processed and select results are used to transform the received data into a clinically relevant output. The clinically relevant output can be configured to distill input data into “at a glance” interpretable reports. The output or report can be viewed on screen or downloaded in a variety of formats including, for example, as a pdf. The report can then be shared with clinicians or other supports at the patient's discretion.

In one example, the system is configured to present an intuitive subject interface (usable in default configuration and supporting user customization). The interface can be configured to present any necessary permissions/waivers, which can be required in order to use the system. Further embodiments can include specialized algorithms configured to identify relevant indicators from patient data, and specialized algorithms for clinical report generation. The system and/or components can be further configured to map patient data to smart templates for drafting and editing clinical notes.

According to one aspect, a system for capturing and analyzing medical information is provided. The system comprises at least one processor operatively connected to a memory, wherein the processor is configured to execute system components from the memory; an interface component configured to accept user responses to medical survey questions; a transformation component configured to transform survey responses associated with a plurality of analysis metrics into a common scale; an evaluation component configured to evaluate the survey responses from the plurality of analysis metrics against a predefined diagnostic threshold, wherein the evaluation component is further configured to identify any medical characteristics that exceed the diagnostic threshold; and a display component configured to generate a summary view including at least the medical characteristics that exceed the diagnostic threshold and the diagnostic threshold applied. In one embodiment, the medical survey questions are configured to assess mood disorder information, and wherein the interface component is further configured to present questions directed to a plurality of mood disorder rating scales.

In one embodiment, the transformation component is further configured to transform survey responses into a common severity rating of a mood disorder symptom. In one embodiment, the diagnostic threshold is defined against criteria for establishing a formal clinical diagnosis of a mood disorder. In one embodiment, the display component is configured to generate a graphical view of the results of answered questions directed to a plurality of mood disorder rating scales; and highlight scores exceeding the diagnostic threshold. In one embodiment, the display component is configured to generate a tabular view of the results of answered questions directed to a plurality of mood disorder rating scales.

In one embodiment, the display component is configured to display diagnostic scores from multiple scoring systems organized by category. In one embodiment, the display component is further configured to highlight diagnostic scores exceeding threshold obtained from multiple score systems for a respective category. In one embodiment, the evaluation component is further configured to auto-generate clinician notes by aggregating patient data and pre-existing evidenced-based treatment information. In one embodiment, the evaluation component is further configured to match a current patient with an existing patient having similar mood disorder characteristics, and present any notes for the existing patient as candidates for including in a current note. In one embodiment, the auto-generated clinician notes generated by the evaluation component are configured for editing by a user with permissions for editing the notes. In one embodiment, the evaluation component is further configured to generate a recommended course of patient treatment based on aggregated patient data identifying medical characteristics that exceed the predefined diagnostic threshold. In one embodiment, the evaluation component is configured to match a current patient with at least one existing patient having similar mood disorder characteristics, and identify treatment options for the at least one existing patient as candidate treatment options. In one embodiment, the evaluation component is further configured to generate a recommended course of patient treatment based on a formal diagnosis of a patient's condition. In one embodiment, the evaluation component is configured to match the formal diagnosis to at least one existing patient, and identify treatment options for the at least one existing patient as candidate treatment options.

According to one aspect, a computer implemented method for capturing and analyzing medical information is provided. The method comprises the acts of accepting, from a user interface, user responses to medical survey questions; transforming, by a computer system, responses associated with a plurality of analysis metrics into a common scale; evaluating, by the computer system, survey responses from the plurality of analysis metrics against a predefined diagnostic threshold, wherein the act of evaluating includes identifying any medical characteristics that exceed the diagnostic threshold; and generating, by the computer system, a summary view for display on a host computer system including at least the medical characteristics that exceed the diagnostic threshold and the diagnostic threshold applied. In one embodiment, the medical survey questions are directed to assessing mood disorder information, and wherein the act of accepting includes an act of presenting to a host computer system questions directed to a plurality of mood disorder rating scales. In one embodiment, the act of transforming includes transforming survey responses into a common severity rating of a mood disorder symptom.

In one embodiment, the diagnostic threshold is defined against criteria for establishing a formal clinical diagnosis of a mood disorder. In one embodiment, the act of generating a summary view further comprises displaying in graphical form the results of answered questions directed to a plurality of mood disorder rating scales. In one embodiment, the act of generating a summary view further comprises displaying in graphical form a visual indication highlighting diagnostic scores that exceed the diagnostic threshold. In one embodiment, the act of generating a summary view further comprises displaying in tabular form the results of answered questions directed to a plurality of mood disorder rating scales.

In one embodiment, the act of evaluating survey responses further comprises auto-generating clinician notes by aggregating patient data and pre-existing evidenced-based treatment information. In one embodiment, auto-generating includes matching a current patient with an existing patient having similar mood disorder characteristics, and presenting any notes for the existing patient as candidates for including in a current note. In one embodiment, the auto-generating of notes further comprises providing functionality for manually editing the auto-generated notes by a user with appropriate permissions for editing.

In one embodiment, the act of evaluating survey responses further comprises generating a recommended course of patient treatment based on aggregated patient data identifying medical characteristics that exceed the predefined threshold. In one embodiment, the act of evaluating survey responses further comprises generating a recommended diagnosis based on aggregated patient data identifying medical characteristics that exceed the predefined threshold. In one embodiment, the act of evaluating survey responses further comprises generating a recommended course of patient treatment based on a formal diagnosis of a patient's condition.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed below with reference to the accompanying figures, which are not intended to be drawn to scale. Where technical features in the figures, detailed description or any claim are followed by reference signs, the reference signs have been included for the sole purpose of increasing the intelligibility of the figures, detailed description, and claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIG. 1 illustrates an example of the paper based forms traditionally required of patients and clinicians used when recording patient history, current patient status, and clinicians' notes;

FIG. 2 illustrates an example system architecture for an evidence-based analysis system, according to one embodiment;

FIG. 3A shows an example user interface presented to patients for personal pre-assessment and treatment history definition, according to one embodiment;

FIG. 3B shows another example user interface presented to patients for personal pre-assessment and treatment history definition, according to one embodiment;

FIG. 4 shows an example of a printable summary, at-a-glance view of current treatment and clinical status for a patient, according to one embodiment;

FIG. 5 shows an example user interface for selecting, scoring, and displaying patient data, according to one embodiment;

FIG. 6 shows an example user interface for managing overall patient information including follow-up notes as presented to a clinician, according to one embodiment;

FIG. 7 illustrates an example user interface for the at-a-glance display of symptom summary patient information data, according to one embodiment;

FIG. 8 illustrates another example user interface for the at-a-glance display of symptom summary patient information data, according to one embodiment;

FIG. 9 illustrates an example user interface for the display of analytics data related to diagnostic reference and population means, according to one embodiment;

FIG. 10 shows an example of an index of diagnostic confidence with estimated scoring methodology, according to one embodiment;

FIG. 11 illustrates an example process for generating diagnostically relevant information for analyzing a patient, according to one embodiment;

FIG. 12 illustrates a flow diagram describing a typical example implementation process of follow-up care for a patient with a mood disorder;

FIG. 13 illustrates another example user interface for the at-a-glance display of symptom summary patient information data, according to one embodiment;

FIG. 14 illustrates a flow diagram describing an example implementation of pre-assessment of a new patient, according to one embodiment; and

FIG. 15 is a block diagram of a general purpose computer system on which various functions can be implemented, according to one embodiment.

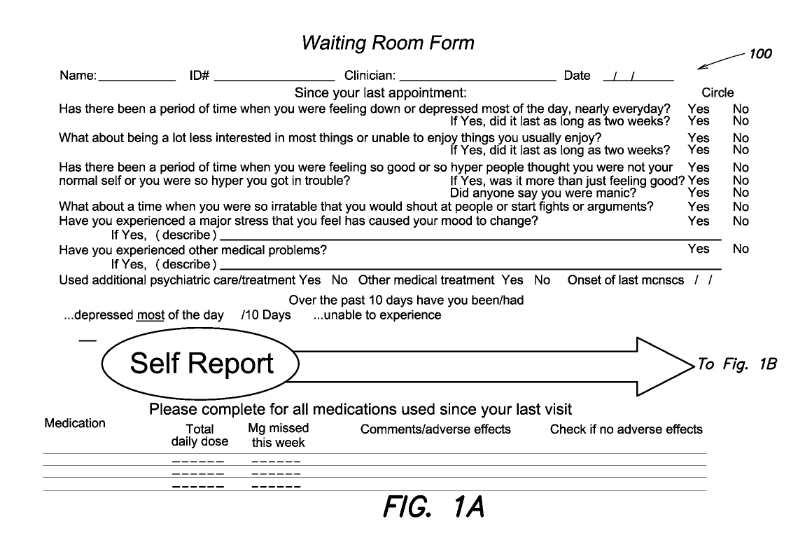

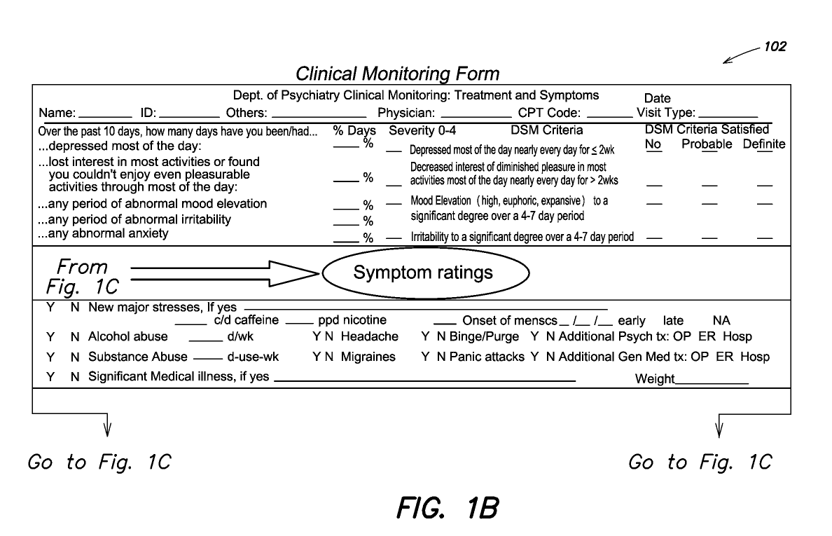

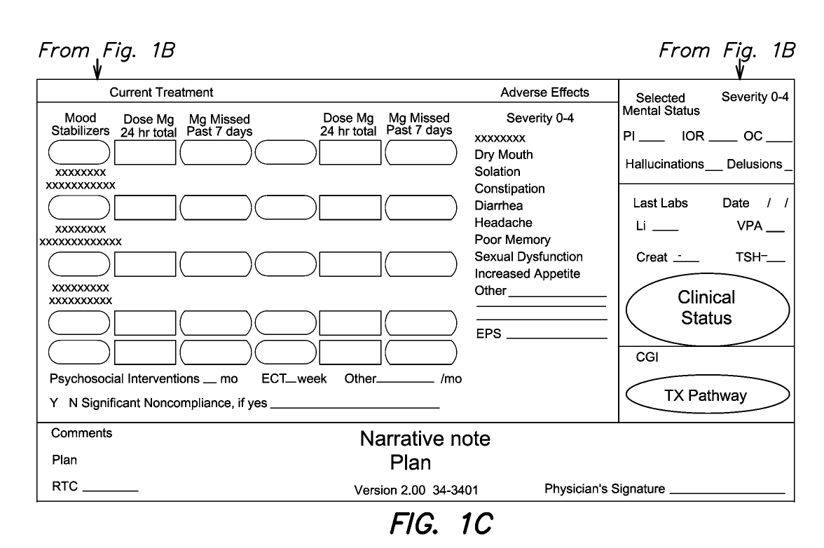

### DETAILED DESCRIPTION

According to some embodiments, clinicians can use analysis systems and tailor reports of symptoms supplied by the patient to facilitate diagnosis, symptom identification, and/or treatment planning. In some embodiments, respective patients are able to input their medical information (e.g., answers to questionnaires, medical symptoms, duration, severity, etc.). In further embodiments, the patients can be given control over their information via user configurable account settings. In one example, patients can use the system to grant or deny access to their information using account settings. In another example, patients can cause the system to deliver an access granting message to a health care provider.

In some examples, access control can be responsive to subscription, and reports generated by the system from patient information can be accessed, for example, by a clinician who has subscribed to the analysis system. According to one embodiment, an analysis system can implement any one or combination of the herein described functionality as an eClinical Assistant product, or other system component. The eClinical Assistant component can be implemented, for example, as software executing on computer hardware, where the executing software is configured to perform any one or more of the functions and operations discussed herein.

Using an eClinical Assistant component, for example, care providers can access additional patient reports, customize assessments for individual patients, and have access to reports based on “smart templates.” Smart templates are generated automatically by the analysis system and/or an eClinical Assistance component. The smart templates can be configured to identify and present clinically relevant information derived from patient reports and/or medical information. In some embodiments, smart templates are used by the system to generate “at-a-glance” displays. The at-a-glance displays are derived automatically by the system, and are specially configured to facilitate clinician recognition of medical issues with a minimal set of displayed data. Further the at-a-glance displays can be configured to facilitate identification of potential issue areas with a minimal set of displayed data. In some implementations, the “at-a-glance” displays can be used by the system to automatically generate an editable first draft of a note for the clinician's record. A note for a clinical record is the primary means of tracking progress and interventions. It typically includes subjective and objective components, an impression and a plan or recommendations. By efficiently documenting information bearing on the clinician's judgment of a patient's clinical status (operationally defined) and quantitative outcome measures, the system can prepare a draft note linking the impression to the decisions for selecting interventions and facilitates measure-based practice.

Various embodiments of an evidence based analysis system can include components that implement algorithms for selecting and transforming collected data onto clinically relevant dimensions. Further embodiments can include components configured to intelligently design outputs for “at-a-glance” communication of complex information necessary to inform clinical judgment. In some examples, automated system selections identify medical information for display, presenting summary data that can facilitate clinician diagnosis and/or analysis with minimal or no training required by the clinician to implement and/or use such diagnostic aids. Such embodiments can be configured to reduce the amount of data a clinician needs to review in order to further diagnostic interaction with a given patient. In some embodiments, system components can be configured for web-based delivery of patient data/information and further embodiments, can include mobile app based delivery.

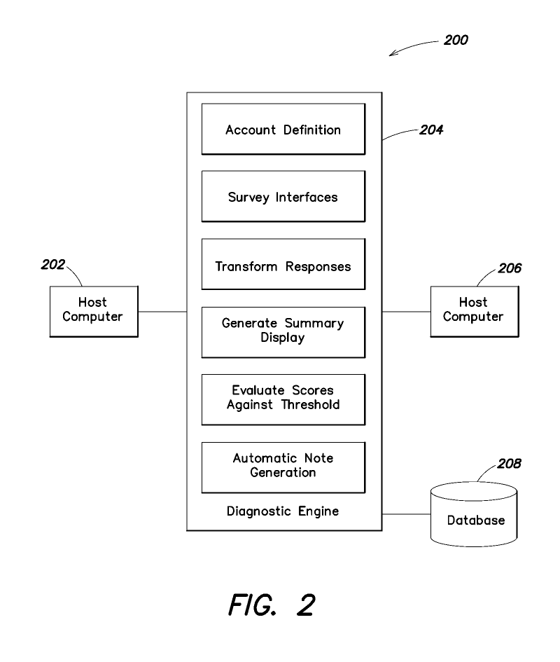

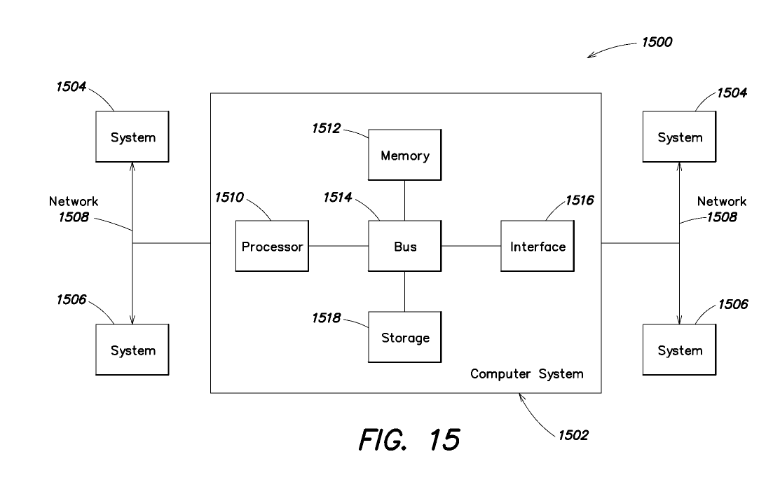

In one implementation, an evidence based analysis system includes a suite of tools that can be configured to collect a customizable set of standard patient facing assessments outside of an office visit. Referring to FIG. 2, there is illustrated one example of a system 200 for accepting and analyzing medical information. The analysis system 200 can include a diagnostic engine 204 executing on one or more computer systems. The one or more computer systems can include computer system 1500 and/or 1502, FIG. 15, discussed in greater detail below.

In some embodiments, the analysis system can implement a diagnostic engine 204 configured to perform any of the functions and/or operations discussed herein. In one example, patients can access the analysis system 200 and/or diagnostic engine 204 from a host computer system 202. In some embodiments, a patient can be given access credentials (user name, temporary password, access link, account set up web address, etc.) to the system by a clinician who has subscribed to use the analysis system 200.

The patient can be asked to establish their account in response to connecting to the analysis system, for example through a web page displaying a browser window on the host computer 202. The analysis system 200 and/or the diagnostic engine 204 can be configured to supply information for definition of patient accounts. In some embodiments, control of patient information is maintained by the patient. For example, the system is configured to limit access to patient information, until another viewer (e.g., a clinician) is explicitly authorized to view the patient's medical information.

In other embodiments, the system can be configured to permit a referring clinician access to medical information responses entered by a patient by default, through a respective host computer 1506. In some examples, a patient setting up an account is notified that by setting up the account they agree to provide such information to their referring clinician. In other examples, the patient must explicitly agree to disclosure terms prior to completing account set up.

According to one embodiment, the patient account and online access to the analysis system 200, becomes the vehicle for capturing and delivering patient symptom information to a clinician. In one aspect, the analysis system and online access enables clinicians to shift the time spent collecting routine information into an information collection task that occurs outside the office. Shifting initial information collection outside of the time allotted for in person interaction can further enable clinicians to focus any further information collection on the most relevant information associated with any patient issues, disorder, problems, indicators, etc.

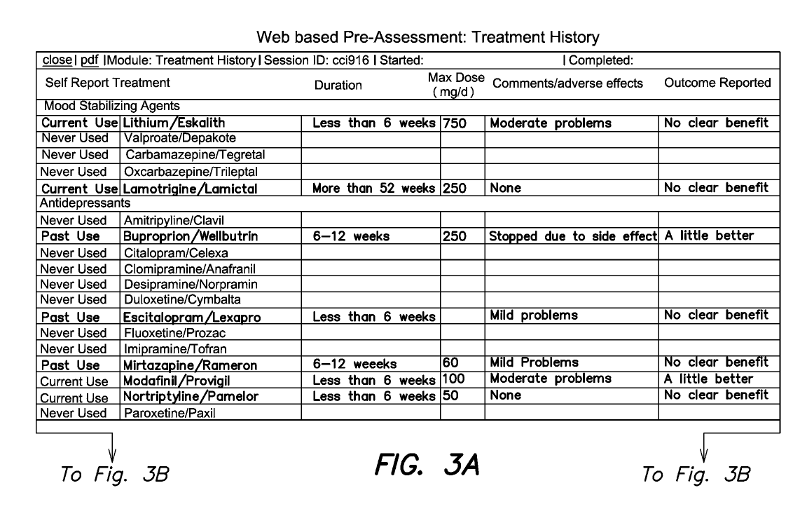

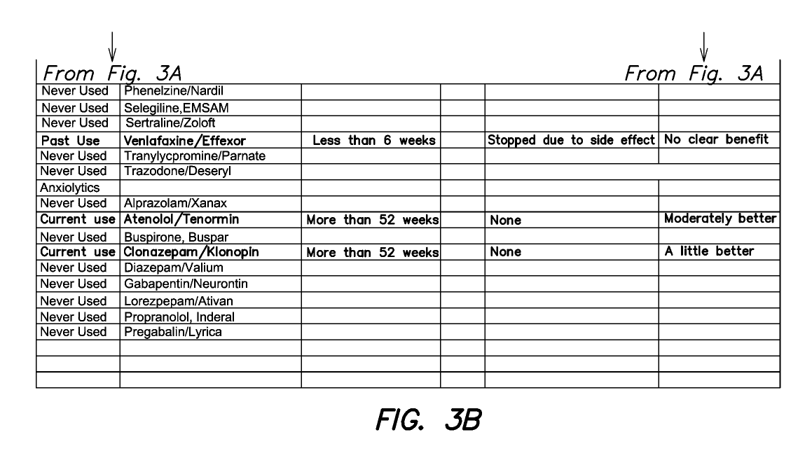

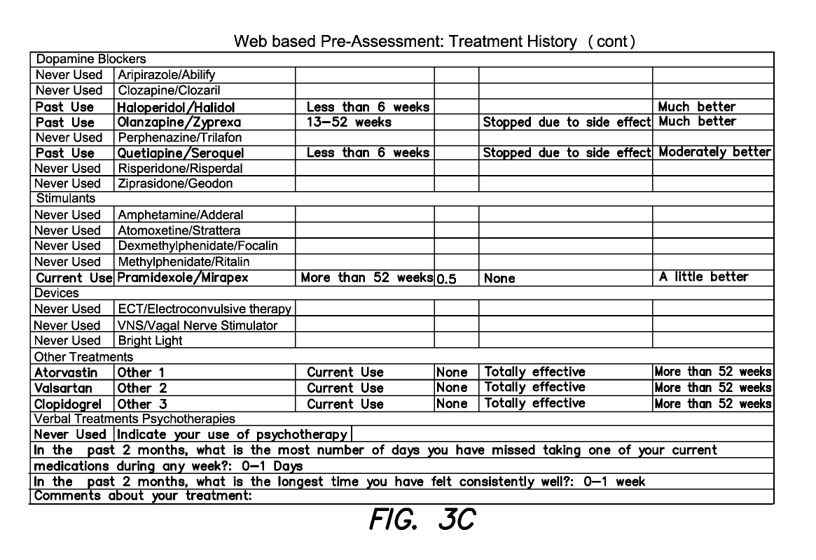

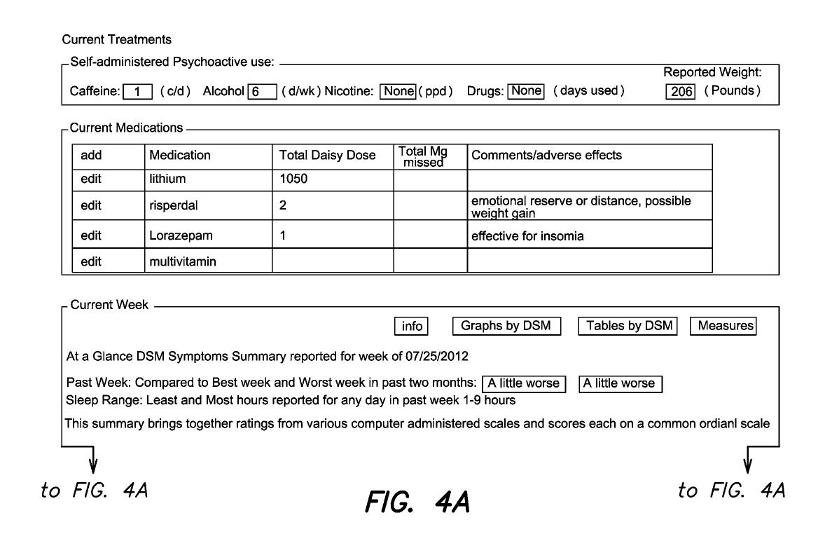

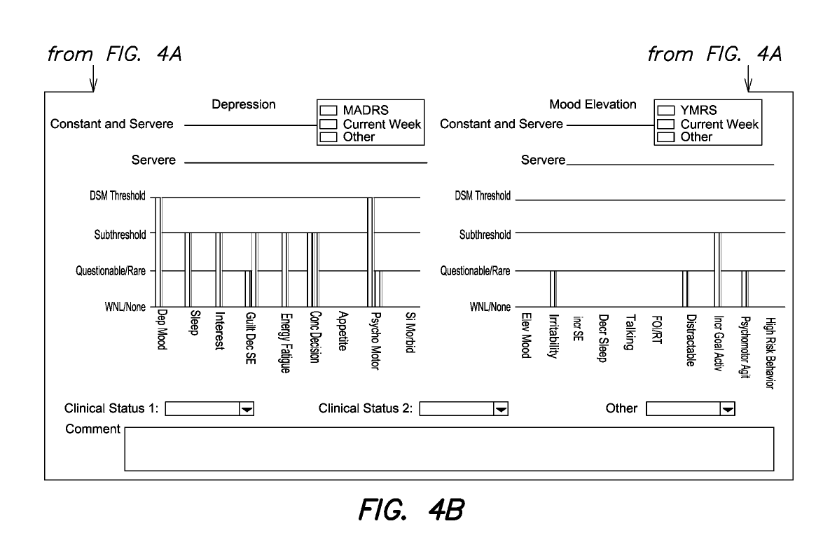

Shown in FIG. 3A, FIG. 3B, FIG. 4 are example user interface displays 300, 302, and 400 generated by the system 100, and any one or more of the example user interface displays can be communicated to the host computer 102 for user input. In some embodiments, the patient is asked to complete all information in the displayed questionnaires. In various embodiments, these web based pre-assessment forms can be completed on-line, at-home, prior to the patient's visit to the clinician's office. In some implementations, specific questions can be selected by the analysis system 100 and presented in user interface displays based on patient responses. User interfaces 300 and 302 illustrate interfaces generated by an example embodiment of the analysis system 100 that is configured to provide patients with user-friendly interfaces for entering information that will assist clinicians in treating and/or analyzing patients with mood disorders.

The system and/or diagnostic engine 204 can be configured to collect patient data through questions displayed in various user interfaces. Data collection can include use of conventional medical scoring systems. In some implementations, the system can collect medical information from patients according to known scoring approaches, including, for example, Montgomery-Asberg Depression Scale (“MADRS”), Hamilton Depression Rating Scale (“HAMD”), Young Mania Rating Scale (“YMRS”), and the Quality of Life Scale (“QOLS”). In further implementations, the system can also be configured to collect pre-assessment data, including for example, any one or more of, diagnostic questions regarding symptoms (e.g., mood disorder symptoms, severity of symptoms, duration/frequency, etc.), regarding baseline depression and/or mood elevation scores, regarding common comorbidities (comorbidity is either the presence of one or more disorders (or diseases) in addition to a primary disease or disorder, or the effect of such additional disorders or diseases), regarding prior treatment(s), regarding general medical history, regarding family medical history, and regarding dimensions of personality. For example, the NEO Five Factor Inventory (Costa and McCrea) assesses the “five factors” of personality (the five broad domains or dimensions of personality that are used to describe human personality—including Openness (inventive/curious vs. consistent/cautious), Conscientiousness (efficient/organized vs. easy-going/careless), Extraversion (outgoing/energetic vs. solitary/reserved), Agreeableness (friendly/compassionate vs. cold/unkind), and Neuroticism (sensitive/nervous vs. secure/confident).

The collected data can be stored by the system, for example, on database 208. Database 210 can include other computer systems, for example, a database server connected to the analysis system 200 and/or diagnostic engine 204, which hosts database services for use by the analysis system and/or diagnostic engine 204.

In various embodiments, the system and/or the diagnostic engine is configured to transform collected data into a common ordinal score having a common scale. In some embodiments, the diagnostic engine can be configured to collect data from patient surveys in the common ordinal scale. For example, patient responses to displayed questions can be constrained to fall within a common scale. In other embodiments, the diagnostic engine can be configured to collect data in any scale defined for the metric being assessed (e.g., MADRS, YMRS, HAMD, QOLS, etc.), and then transform the data in a common scale. In further embodiments, the system is configured to incorporate a variety of testing methodologies and respective scorings and combine them into a single common diagnostic score.

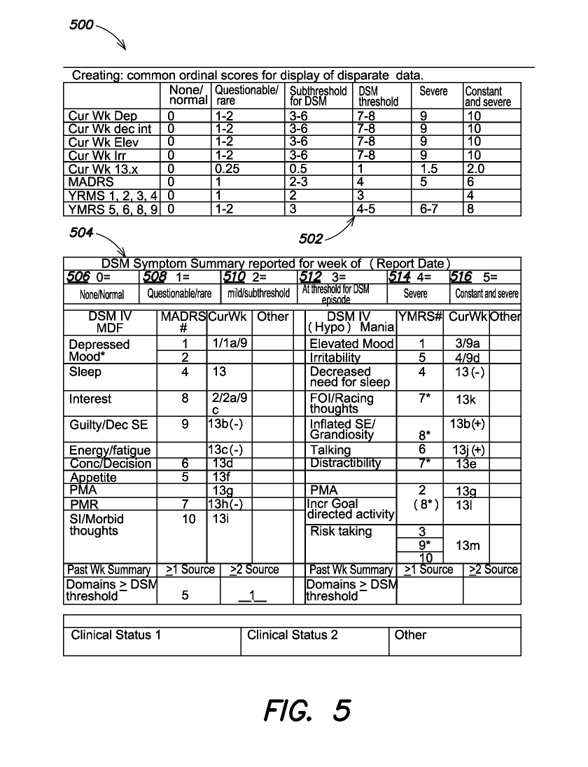

According to one aspect, transforming the various metrics collected which can be associated, for example, with a patient's mood, into a diagnostic score on a common ordinal score enables the system to identify the most relevant data, and present the most relevant data in the context of the variety of scoring metrics captured by the system. According to further aspects, identifying relevant data for clinical analysis provides only part of a clinical picture, including the context in which the relevant data is identified provides greater insight to a clinician. Further, highlighting why a particular feature or response is relevant in the context of other scoring methodologies facilitates clinical confidence in any identification. One example transformation approach that can be executed by the system 200 and/or the diagnostic engine 204 is illustrated in FIG. 5, as discussed in more detail below.

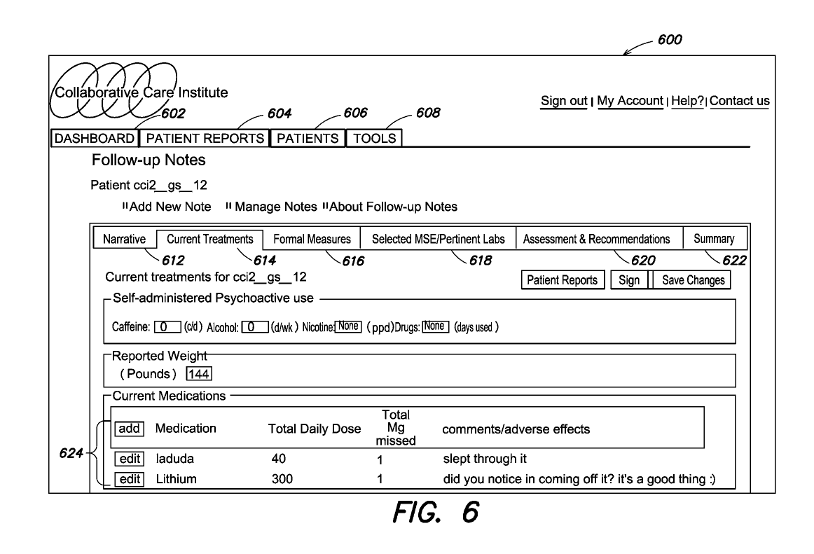

According to some embodiments, medical information collected by the system is presented to a clinician as an interface that allows for browsing through various components of a patient's medical history, current conditions, current treatments, as well as assessments and recommendations that may be pertinent to a particular patient. As shown in FIG. 6, an example user interface 600 for a clinician's view on the analysis system site as presented to a clinician can contain dashboard 602 functionality for presenting a high-level overview of the clinician's practice, links to patient reports 604, lists of patients 606, as well as other tools 608. In some embodiments, these tools may include the ability to enter patient follow-up notes 610, compose a narrative 612 about the patient, view current treatments 614 a particular patient is undertaking, view types of formal measures 616 that could be applicable to the patient, view lab work 618 the patient has undergone, view prior assessments and recommendations 620, and view summary information 622 about a patient. In some embodiments, the fields 624 presented within each of these views may be editable by a clinician with appropriate privileges for editing the information.

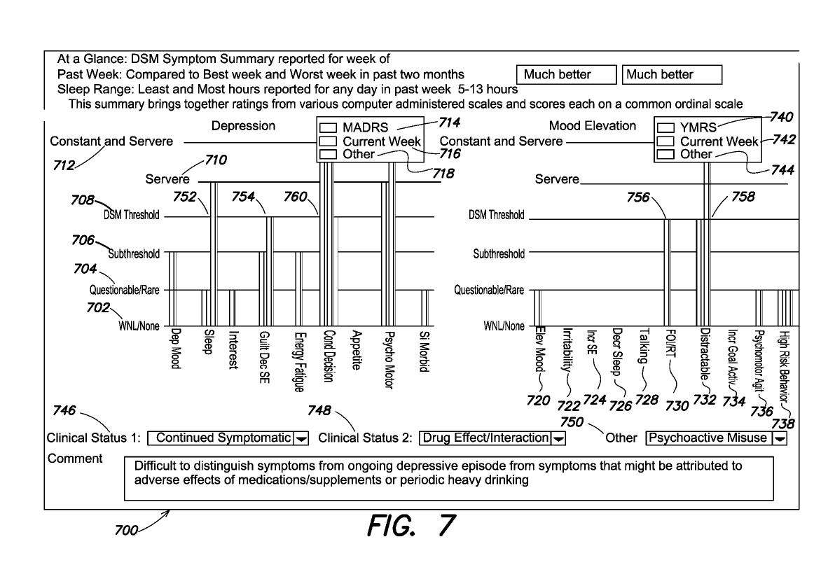

According to some embodiments, medical information collected by the system is evaluated against a diagnostic threshold, to automatically identify clinical dimensions (e.g., mood scoring items—individual criteria on any one or more of the MADRS, YMRS, HAMD, QOLS, evaluations) that are particularly relevant for diagnostics analysis. The diagnostic threshold can be pre-configured on the analysis system. In a mood disorder setting, the threshold can be configured to reflect criteria for diagnosing a mood disorder. In one example, diagnosing major depression requires that a patient have moderate or greater symptoms in 5 or more mood dimension (e.g., reported sadness, observed sadness, inner tension, reduced sleep, reduced appetite, concentration difficulties, lassitude, inability to feel, pessimistic thoughts, SI/morbid thoughts, etc.). Each mood symptom reported by a patient can be evaluated by the system and/or diagnostic engine against a moderate threshold. Shown in FIG. 7 is a graphical display 700 generated by the system and/or diagnostic engine 204, displaying mood dimensions highlighting the threshold 708 (e.g., “Threshold”) used to evaluate each dimension. Further, the generated display 700 of FIG. 7 can include a designation for “Subthreshold” scores 706. Each mood dimension can be displayed according to an associated level for the symptom (e.g., “Normal/None” 702, “Questionable/Rare” 704, “Subthreshold” 706, “Threshold” 708, “Severe” 710, and “Constant/Severe” 712 among other examples).

In some embodiments, a user interface display can include displays on patient mood dimensions captured from multiple analysis sources. In particular, as shown in FIG. 7, three analysis sources are plotted on the example graphical display, MADRS 714 (associated with transformed MADRS questions, responses, and scores for each dimension), Current Week 716 (associated with patient responses on their current symptoms for the week preceding the analysis), and Other 718 (associated with appropriate items selected from another scale or questionnaire the clinician has configured the system to administer as part of the assessment battery, which can include, ins some examples, the Hamilton Anxiety Rating Scale or the Young Mania Rating Scale). By providing a visual representation of the scoring assigned to a particular patient for various symptoms, a clinician can quickly see if that patient has multiple symptoms which would meet a DSM threshold criteria for depression or other conditions on either a single measure or multiple measures. By seeing the context of multiple measurements from multiple criteria, the clinician has greater ability to provide a confident diagnosis of a major depressive episode, hypomanic state, or other diagnosable condition. Providing context for multiple symptoms in relation to multiple conditions also provides capabilities for diagnosing mixed episodes. For example, scores that meet or exceed the threshold for a single scale (e.g. 752, 754, and 756) are significant, but not as significant as scores exceeding threshold on multiple scoring systems. At 758, the mood elevation category distractibility 732 exceeds threshold on two measures (YRMS 740 and Current Week 742). The system can be configured to highlight scores that exceed threshold on multiple measurements. In some examples, different visual highlighting can be used for each additional measurement exceeded (e.g., at 758 exceeds MADRS 714, Current Week 716, and Other 718).

As shown in FIG. 7, patient mood dimensions can also be graphed for analysis of Mood Elevation on the same scale, plotting for example, elevated mood 720, irritability 722, inflated SE/grandiosity 724, decreased need for sleep 726, talking 728, FOI/Racing thoughts 730, distractibility 732, increased goal directed activity 734, PMA (psychomotor agitation) 736, and risk taking 738, for as many analysis sources that are available. In the example display 700, the mood dimensions are plotted against information obtained for YMRS 740, Current Week 742, and Other 744. Additional and/or different scoring information can be included in other embodiments.

The system and/or diagnostic engine can be further configured with a variety of predefined thresholds that are selected by the system in response to clinical status of a given patient. For example, as shown in FIG. 7, under the graphical displays of mood dimensions, clinical status 746 and 748 are displayed. Clinical status can be set by a clinician, and any such status can be stored by the system as a default setting responsive to any further changes by a reviewing clinician. Each clinical status can be associated with different thresholds for analysis medical dimensions, including, for example, patient mood dimensions shown in FIG. 7.

The system can be configured to automatically adjust predefined thresholds and even medical dimensions being displayed responsive to selection of clinical status. For example, while an initial diagnosis of a major mood disorder may require 5 symptoms of moderate or greater severity over a two week period, an already diagnosed patient can be identified as continuing to have a major mood disorder under less rigorous criteria. In one example, the patient can be diagnosed with a major mood disorder where 3 or more symptoms are of moderate or greater severity following the major mood disorder diagnosis. “Continued Symptomatic” can be defined on the system as a clinical status (e.g. shown at 746). Identification of a patient as continued symptomatic can facilitate clinical analysis. Additional status can be defined including for example, “recovering” (2 or less symptoms of moderate or greater severity), roughening (increase in number of symptoms of moderate or greater severity), recovered (8 weeks of less than two symptoms of moderate or greater severity), etc.

In some embodiments, multiple statuses can alter predefined thresholds and/or selection of displayed medical dimensions. According to other embodiments, the system can also be responsive to clinical classifications that do not necessarily fall into a clinical status, e.g., shown under “Other” 750 is psychoactive misuse. The psychoactive misuse classifier allows the clinician to recognize patterns of problematic use that do not necessarily correspond to all aspects of the full criteria sets defining substance abuse or dependence.

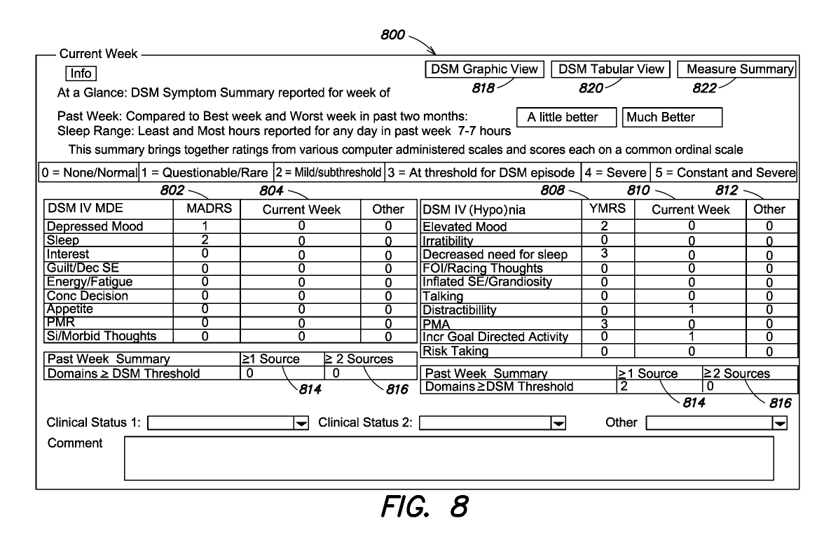

Other views can be presented to clinicians, for example on host computer 106. FIG. 8 illustrates an example user interface display 800. The display 800 presents the mood dimensions of FIG. 7 organized in a tabular or spreadsheet format. The tabular view can be configured to organize the mood dimensions based on information source (e.g., MADRS 802, Current Week 804, Other 806, YMRS 808, Current Week 810, Other 812). In some embodiments, the system and/or diagnostic engine 204 can be configured to generate the tabular display using transformed data. The summary of transformed data presented in 800 can bring together ratings from various computer administered scales and can score each on a common ordinal scale. In further embodiments, the system and/or diagnostic engine is configured to provide summary information from a perspective of high sensitivity and a separate view from a perspective of higher specificity. For example, as is known in the art, sensitivity of mood disorder data reflects how sensitive a given analysis is at detecting a potential disorder. In the displayed example 800, sensitivity is displayed by the column “>1 Source” 814. The column reflects how many dimensions meet or exceed a diagnostic threshold.

The column for “>=2 Sources” 816 provides an indication of specificity of diagnosis by displaying how many dimensions of the diagnosis are confirmed by more than one source. The greater specificity of the potential diagnosis the greater the confidence a clinician can have in the indicators for a potential disorder. In addition to the tabular display of data, the user interface can be configured to toggle between views of the relevant data. Selection of “Graphic View” 818 can be configured to transition the user interface to a graphical display (e.g., as shown in FIG. 7). The “Tabular View” 820 display reflects the current view shown, for example, in FIG. 8.

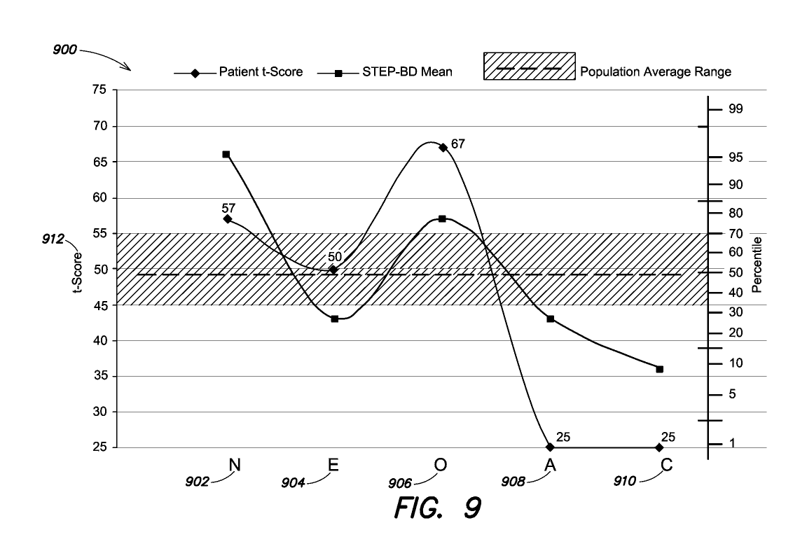

The user interface can further be configured to transition to a “Measure Summary,” (e.g. by selecting 822) shown for example in FIG. 9. Shown in FIG. 9 is a graph of the five factors of personality (the five broad domains or dimensions of personality that are used to describe human personality—including Openness 906 (inventive/curious vs. consistent/cautious), Conscientiousness 910 (efficient/organized vs. easy-going/careless), Extraversion 904 (outgoing/energetic vs. solitary/reserved), Agreeableness 908 (friendly/compassionate vs. cold/unkind), and Neuroticism 902 (sensitive/nervous vs. secure/confident) in relation to diagnostic reference and standard population means.

Scales such as the NEO FFI generate raw scores in each of the five personality traits which are transformed to t-scores 912, by looking up the value for the raw score in the distribution scores for the general population. This process is often confusing for clinicians. The CCI system can be configured to automate the scoring and generate a graphical display of scores in reference both to the general population and a diagnostic reference population selected by the clinician from data sets stored in the CCI system (i.e. a population having the same or similar mood disorder as the patient being analyzed). Diagnostic references can be typically drawn from published studies of subjects with common medical conditions and/or mood disorders. Any publically available or published data can be stored, for example, in database 208 and be used in comparison plots (e.g., FIG. 9). In addition, the scores for the patient being analyzed can be plotted against both the standard population scored and the diagnostic reference population. Providing the graphical display of personality factors enables a clinician to easily and quickly recognize potential issues for a given patient. In this particular example, the largest deviation appears under the Agreeableness factor, informing a reviewing clinician that one of the first areas for treating the patient that needs to be addressed is the patient's Agreeableness. Some patterns have been associated with high placebo response clinical trials and may encourage greater consideration of alternative treatment plans.

In some embodiments, the system 200 and/or diagnostic engine 204 can be further configured to generate confidence scores associated with analysis of patient supplied symptom information. In one embodiment, the system is configured to generate an estimated Bipolarity Index confidence score based on responses to questionnaires input by a patient (e.g., on host computer 202). In one example, a Lifetime Illness Characteristic Questionnaire (LICQ) can be presented to a patient by the system, 200. The LICQ can be presented on host computer 202, and the patients responses scored by the system. In one embodiment, the questionnaire is configured to establish an additive score in five categories: episode characteristics; physical factors; course of illness/associated features; response to treatment; and family history. The system and/or diagnostic engine 204 is configured to present questions to the patient to establish within each category a score reflective of their symptoms.

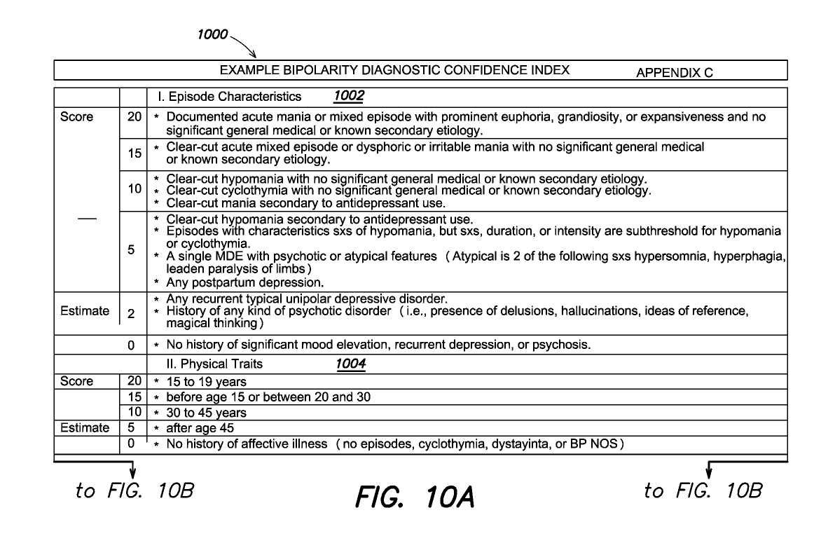

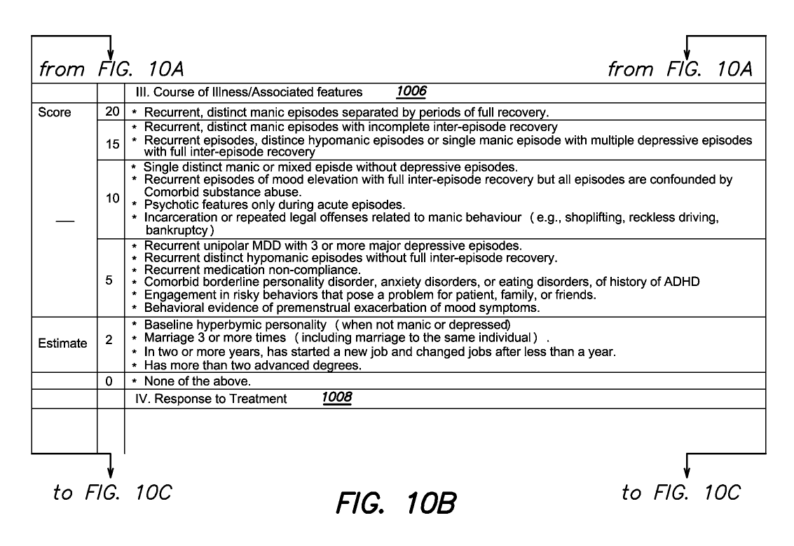

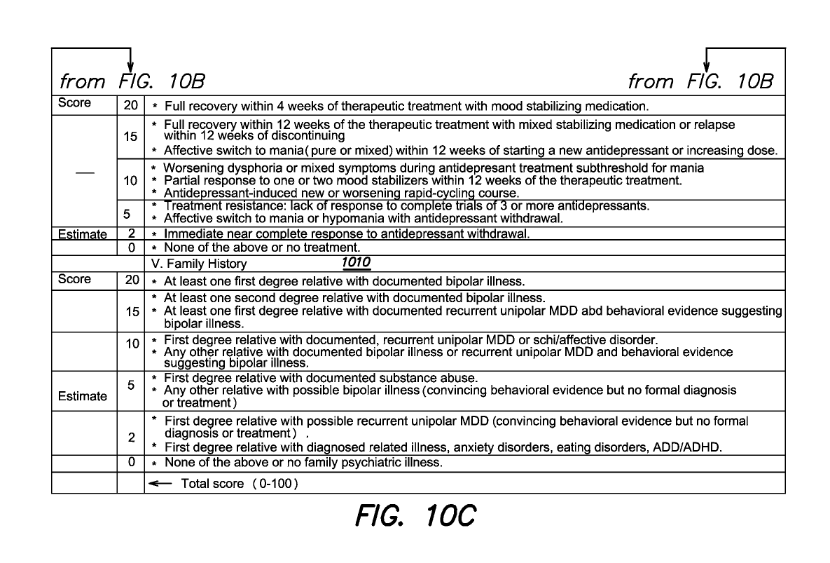

Shown in FIG. 10 is an example bipolarity diagnostic confidence index 1000. According to some embodiments, questions are presented by the system to establish for each category an associated score, based on the identified characteristics. In some embodiments, the categories may include such grouping as “Episode Characteristics” 1002, “Physical Traits” 1004, “Course of Illness/Associated Features” 1006, “Response to Treatment” 1008, and “Family History” 1010. The scores in each category are combined to provide an overall confidence score that informs a clinician of the qualitative level of confidence the clinician can have in a given indicator.

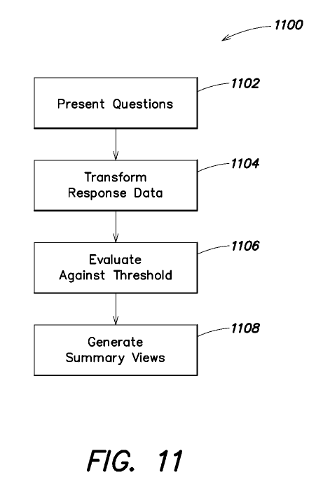

FIG. 11 shows one example of a process flow 1100 for generating diagnostically relevant information for analyzing a patient. Process 1100 begins at 1102 with presenting questionnaires to a patient in user interface. As discussed, the user interface can be displayed on any computer system, including mobile devices, cell phones, pda, etc. The questionnaires can include questions that target conventional diagnostic scorings. For example, questions to capture MADRS, YMRS, QOLS, HAMD, metrics can be presented. At 1104, any response captured in a variety of formats and/or scales can be transformed in a common ordinal scale. Within the transformed data general categories reflective of the transformed data can be evaluated against diagnostic thresholds. Typically, specific diagnoses have precise requirements that apply a set of criteria to a patient.

For example, in the mood disorder setting, a patient must have a moderate or greater symptom in at least five mood dimensions in order to be diagnosed as having a major mood disorder. General categories can be determined from specific requirements for the set of criteria associated with a variety of diagnoses. Questions can be selected by an analysis system for presentation in step 1102, to elicit responses within each general category. Scoring within each category can be obtained in multiple scoring schemas (e.g., MADRS represents one scoring methodology having its own criteria, HAMD represents another, further scorings can also be obtained in other ways, for example, from patient's directly reporting symptoms “Current Week”). Scoring in each category obtained from the scoring methodologies and/or information sources can be evaluated against diagnostic thresholds at 1106. For example, determining which mood dimension would contribute to a major mood disorder diagnosis can be established by determining if they exceed a threshold. Symptoms can be evaluated to determine if they meet or exceed a moderate severity score, for example, at 1106. The scored and the evaluation threshold can be used to generate summary views of patient data, for example, at 1108. Examples of the generated displays are shown in 700, 800, and 900 of FIG. 7, FIG. 8, and FIG. 9 respectively.

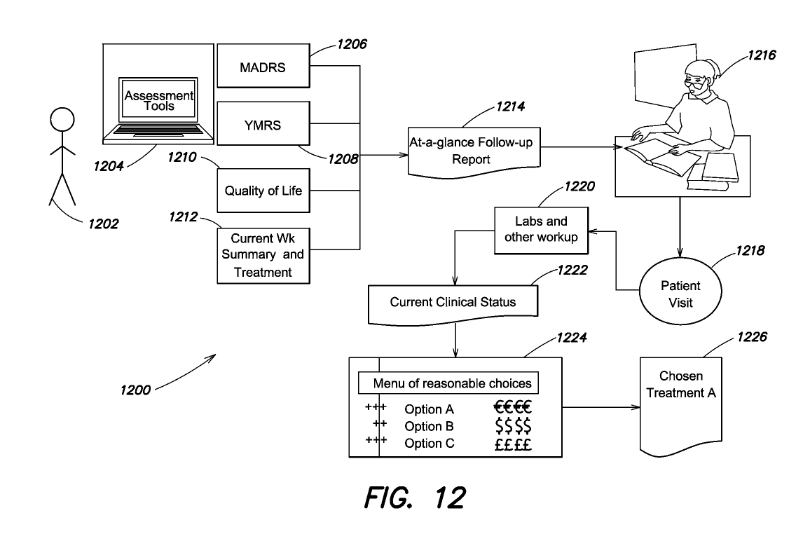

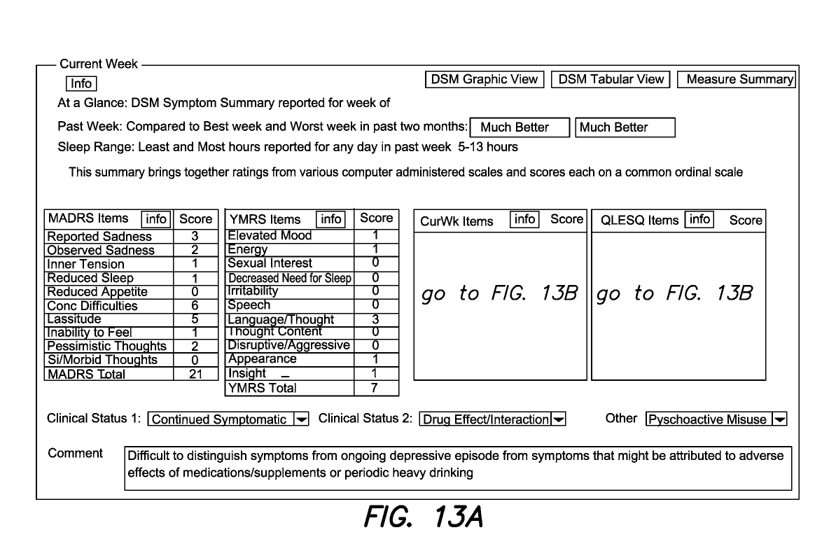

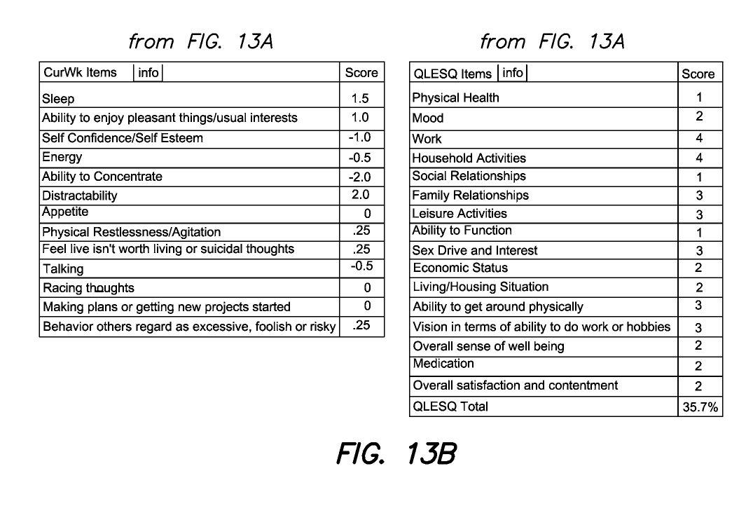

FIG. 12 illustrates a conceptual flow 1200 for capturing and analyzing clinically relevant patient mood information. As shown in FIG. 12, the patient 1202 can log into an analysis system 1204 operating on a computer system, such as system 1506 in FIG. 15, prior to an office visit with their clinician (e.g. 1-5 days prior to a scheduled visit). The system can be configured to present a variety of questionnaires 1206, 1208, 1210, and 1212 configured to elicit patient responses for a variety of mood dimensions. The responses associated with each mood dimension can be used to establish a score under each mood dimension (including for example, each item listed with a score in FIG. 13). Conventional scoring system can have different ordinalities and can be set to different scales, thus conventional metrics for diagnosing patients cannot be compared directly. In some embodiments, the system can be configured to transform the disparate scales into a common ordinal score.

FIG. 5 illustrates an example transformations that can be executed by the system to derive a common scale and common ordinal scores across a variety of mood disorder metrics. Shown in FIG. 5, a common scale is mapped to each potential score under each evaluation criteria. In various embodiments, an analysis system can be configured to map conventional scores in conventional scoring system to a common scale. Shown in FIG. 5 is an example common scale “0=None/Normal” 504; “1=Questionable/Rare” 506; “2=Mild/Subthreshold” 508; “3=Moderate/Threshold” 510 (threshold can be system configurable and established differently for different clinical settings); “4=Severe” 512; and “5=Constant and Severe” 514. The first table 500 of FIG. 5A illustrates the example mapping from a variety of scoring metrics and scoring items to the common scale. In some embodiments, the scoring items from each metric (e.g., as shown in FIG. 13) can be combined into more general categories, for example, as shown in the symptom summary chart 502 of FIG. 5.

The example view 500 summarizes DSM IV criteria with a high sensitivity (any symptom meeting DSM criterion) and high confidence (>1 source with symptom meeting DSM criterion) for the nine symptoms defining depression and the nine symptoms defining hypomania/mania. In the example 500, depression symptoms can be arrayed based on MADRS number and mood elevation symptoms can be sequenced with symptoms conceptually related to the depressive symptoms in the same row. Where the DSM criteria can be defined with two alternative definitions (e.g. PMA or PMR, PMA or Increased Goal directed Activity) the highest score can be displayed. Where a source has multiple scores related to a single DSM domain (e.g. Risk Taking), the highest score can be displayed. With this information, care providers can apply clinical judgment to assign a clinical status.

Returning to the conceptual flow illustrated in FIG. 12, once the data has been collected and transformed, the system can be configured to prepare at a glance reports 1214 for clinician 1216 review (e.g., 700, 800, and 900 of FIG. 7, FIG. 8, and FIG. 9 respectively). The reports can be used by a clinician to facilitate their interaction 1218 with the patient, and can further allow the clinician to focus on specific issues, disorders, etc., and/or confirm those issues identified in the reports with direct interaction with the patient. Laboratory information 1220 and, for example, clinical status 1222 can also be used in conjunction with reported information to determine reasonable treatment option 1224 develop a reasoned treatment strategy 1226.

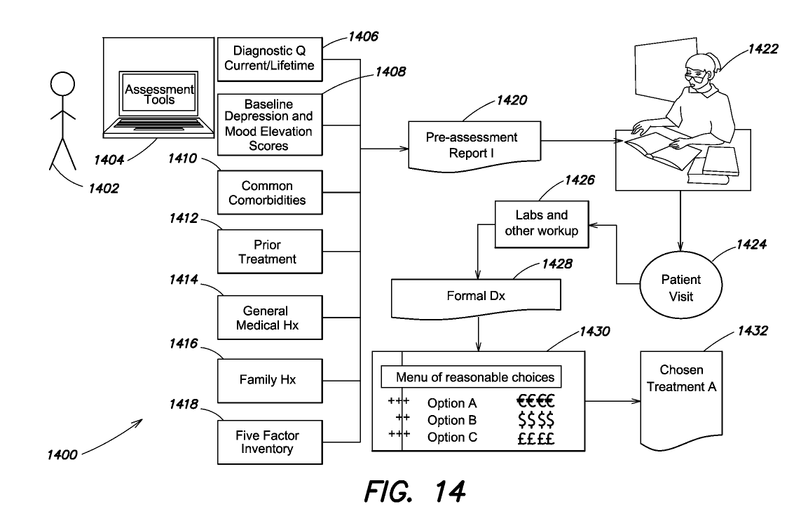

Shown in FIG. 14 is another example of a conceptual flow 1400. The flow 1400 illustrated is defined to capture patient information for “pre-assessment” of a new patient entering a clinical setting. A clinician 1422 can provide access credentials to the new patient 1402, and request that the patient complete the survey questions prior to a scheduled visit. The patient can log into the analysis system 1404 and respond to the questions presented.

The requested data can include responses to diagnostic questions regarding symptoms 1406 (e.g., mood disorder symptoms, severity of symptoms, duration/frequency, etc.), regarding baseline depression and/or mood elevation scores 1408, regarding common comorbidities 1410 (comorbidity is either the presence of one or more disorders (or diseases) in addition to a primary disease or disorder, or the effect of such additional disorders or diseases), regarding prior treatment(s) 1412, regarding general medical history 1414, regarding family medical history 1416, and regarding the “five factors” of personality 1418 (the five broad domains or dimensions of personality that are used to describe human personality—including Openness (inventive/curious vs. consistent/cautious), Conscientiousness (efficient/organized vs. easy-going/careless), Extraversion (outgoing/energetic vs. solitary/reserved), Agreeableness (friendly/compassionate vs. cold/unkind), and Neuroticism (sensitive/nervous vs. secure/confident).

The system can be configured to transform any scoring of their answers into a common scale that facilitates direct comparisons of the disparate metrics. In some embodiments, the system uses the data provided and the transformed scorings to generate pre-assessment reports 1420 (which can be formatted like 700, 800, and 900 of FIG. 7, FIG. 8, and FIG. 9 respectively). The clinician 1422 can quickly review the summary reports to identify specific issues and/or disorders for follow-up and confirmation during direct interaction with the patient during the visit 1424. Further, labs and other tests 1426 can be implemented to further inform a formal diagnosis 1428 for the patient. The system can also facilitate selection of treatment 1432 from various options 1430 responsive to a formal diagnosis 1428 and/or a clinical state set for the patient on the system.

In some settings, the analysis system 200 can facilitate formal diagnosis by identifying medical symptoms that exceed thresholds. The system can be further configured to capture such threshold information and automatically generate a clinical note (i.e., diagnosis of disorder) based on the identified characteristics, severity, and any other relevant data that can be incorporated into the analysis presented in the clinical note. In some embodiments, auto-generation of clinical notes can be enhanced through the use of smart-templates that map current patient data to prior evidence-based treatment information associated with various conditions. In some cases, the clinician with appropriate editing privileges may decide to further edit these auto-generated notes prior to exiting from a patient's file. By automatically aggregating relevant information, the system facilitates accurate and consistent diagnosis.

### Example Computer Implementations

Various aspects and functions described herein, in accord with aspects of the present invention, may be implemented as hardware, software, or a combination of hardware and software on one or more computer systems. There are many examples of computer systems currently in use. Some examples include, among others, network appliances, personal computers, workstations, mainframes, networked clients, servers, media servers, application servers, database servers, web servers, and virtual servers. Other examples of computer systems may include mobile computing devices, such as cellular phones and personal digital assistants, and network equipment, such as load balancers, routers and switches. Additionally, aspects in accord with the present invention may be located on a single computer system or may be distributed among one or more computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system placements and components using a variety of hardware and software configurations, and the implementation is not limited to any particular distributed architecture, network, or communication protocol. Furthermore, aspects in accord with the present invention may be implemented as specially-programmed hardware and/or software.

FIG. 15 shows a block diagram of a distributed computer system 1500, in which various aspects and functions in accord with the present invention may be practiced. The distributed computer system 1500 may include one more computer systems. For example, as illustrated, the distributed computer system 1500 includes three computer systems 1502, 1504 and 1506. As shown, the computer systems 1502, 1504 and 1506 are interconnected by, and may exchange data through, a communication network 1508. The network 1508 may include any communication network through which computer systems may exchange data. To exchange data via the network 1508, the computer systems 1502, 1504 and 1506 and the network 1508 may use various methods, protocols and standards including, among others, token ring, Ethernet, Wireless Ethernet, Bluetooth, TCP/IP, UDP, HTTP, FTP, SNMP, SMS, MMS, SS7, JSON, XML, REST, SOAP, CORBA HOP, RMI, DCOM and Web Services.

Computer systems 1502, 1504 and 1506 may include mobile device such as cellular telephones. The communication network may further employ one or more mobile access technologies including 2nd (2G), 3rd (3G), 4th (4G or LTE) generation radio access for cellular systems, WLAN, Wireless Router (WR) mesh, and other communication technologies. Access technologies such as 2G, 3G, 4G and LTE and future access networks may enable wide area coverage for mobile devices. For example, the network may enable a radio connection through a radio network access such as Global System for Mobil communication (GSM), General Packet Radio Services (GPRS), Enhanced Data GSM Environment (EDGE), Wideband Code Division Multiple Access (WCDMA), among other communication standards. Network may include any wireless communication mechanism by which information may travel between the devices and other computing devices in the network.

To ensure data transfer is secure, the computer systems 1502, 1504 and 1506 may transmit data via the network 1508 using a variety of security measures including TSL, SSL or VPN, among other security techniques. While the distributed computer system 1500 illustrates three networked computer systems, the distributed computer system 1500 may include any number of computer systems, networked using any medium and communication protocol.

Various aspects and functions in accord with the present invention may be implemented as specialized hardware or software executing in one or more computer systems including the computer system 1502 shown in FIG. 15. As depicted, the computer system 1502 includes a processor 1510, a memory 1512, a bus 1514, an interface 1516 and a storage system 1518. The processor 1510, which may include one or more microprocessors or other types of controllers, can perform a series of instructions that manipulate data. The processor 1510 may be a well-known, commercially available processor such as an Intel Pentium, Intel Atom, ARM Processor, Motorola PowerPC, SGI MIPS, Sun UltraSPARC, or Hewlett-Packard PA-RISC processor, or may be any other type of processor or controller as many other processors and controllers are available. As shown, the processor 1510 is connected to other system placements, including a memory 1512, by the bus 1514.

The memory 1512 may be used for storing programs and data during operation of the computer system 1502. Thus, the memory 1512 may be a relatively high performance, volatile, random access memory such as a dynamic random access memory (DRAM) or static memory (SRAM). However, the memory 1512 may include any device for storing data, such as a disk drive or other non-volatile storage device, such as flash memory or phase-change memory (PCM). Various embodiments in accord with the present invention can organize the memory 1512 into particularized and, in some cases, unique structures to perform the aspects and functions disclosed herein.

Components of the computer system 1502 may be coupled by an interconnection element such as the bus 1514. The bus 1514 may include one or more physical busses (for example, busses between components that are integrated within a same machine), and may include any communication coupling between system placements including specialized or standard computing bus technologies such as IDE, SCSI, PCI and InfiniBand. Thus, the bus 1514 enables communications (for example, data and instructions) to be exchanged between system components of the computer system 1502.

Computer system 1502 also includes one or more interface devices 1516 such as input devices, output devices and combination input/output devices. The interface devices 1516 may receive input, provide output, or both. For example, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 1516 allow the computer system 1502 to exchange information and communicate with external entities, such as users and other systems.

Storage system 1518 may include a computer-readable and computer-writeable nonvolatile storage medium in which instructions are stored that define a program to be executed by the processor. The storage system 1518 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein.

A medium that can be used with various embodiments may include, for example, optical disk, magnetic disk or flash memory, among others. In operation, the processor 1510 or some other controller may cause data to be read from the nonvolatile recording medium into another memory, such as the memory 1512, that allows for faster access to the information by the processor 1510 than does the storage medium included in the storage system 1518. The memory may be located in the storage system 1518 or in the memory 1512. The processor 1510 may manipulate the data within the memory 1512, and then copy the data to the medium associated with the storage system 1518 after processing is completed. A variety of components may manage data movement between the medium and the memory 1512, and the invention is not limited thereto.

Further, the invention is not limited to a particular memory system or storage system. Although the computer system 1502 is shown by way of example as one type of computer system upon which various aspects and functions in accord with the present invention may be practiced, aspects of the invention are not limited to being implemented on the computer system, shown in FIG. 15. Various aspects and functions in accord with the present invention may be practiced on one or more computers having different architectures or components than that shown in FIG. 15. For instance, the computer system 1502 may include specially-programmed, special-purpose hardware, such as for example, an application-specific integrated circuit (ASIC) tailored to perform a particular operation disclosed herein. Another embodiment may perform the same function using several general-purpose computing devices running MAC OS System X with Motorola PowerPC processors and several specialized computing devices running proprietary hardware and operating systems.

The computer system 1502 may include an operating system that manages at least a portion of the hardware placements included in computer system 1502. A processor or controller, such as processor 1510, may execute an operating system which may be, among others, a Windows-based operating system (for example, Windows NT, Windows 2000/ME, Windows XP, Windows 7, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, functions in accord with aspects of the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various functions in accord with aspects of the present invention may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed placements, or any combination thereof. For example, a web page may be implemented using HTML while a data object called from within the web page may be written in C++. Thus, the invention is not limited to a specific programming language and any suitable programming language could also be used.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention.

Accordingly, the foregoing description and drawings are by way of example only.

What is claimed is:

1. A system for capturing and analyzing medical information, the system comprising:
at least one processor operatively connected to a memory, wherein the processor is configured to execute system components from the memory;
an interface component configured to accept user responses to medical survey questions;
a transformation component configured to transform survey responses associated with a plurality of analysis metrics into a common scale;
an evaluation component configured to evaluate the survey responses from the plurality of analysis metrics against a predefined diagnostic threshold, wherein the evaluation component is further configured to identify any medical characteristics that exceed the diagnostic threshold; and
a display component configured to generate a summary view including at least the medical characteristics that exceed the diagnostic threshold and the diagnostic threshold applied.

2. The system according to claim 1, wherein the medical survey questions are configured to assess mood disorder information, and wherein the interface component is further configured to present questions directed to a plurality of mood disorder rating scales.

3. The system according to claim 2, wherein the transformation component is further configured to transform survey responses into a common severity rating of a mood disorder symptom.

4. The system according to claim 2, wherein the diagnostic threshold is defined against criteria for establishing a formal clinical diagnosis of a mood disorder.

5. The system according to claim 3, wherein the display component is configured to generate a graphical view of the results of answered questions directed to a plurality of mood disorder rating scales; and highlight scores exceeding the diagnostic threshold.

6. The system according to claim 3, wherein the display component is configured to generate a tabular view of the results of answered questions directed to a plurality of mood disorder rating scales.

7. The system according to claim 3, wherein the display component is configured to display diagnostic scores from multiple scoring systems organized by category.

8. The system according to claim 7, wherein the display component is further configured to highlight diagnostic scores exceeding threshold obtained from multiple score systems for a respective category.

9. The system according to claim 1, wherein the evaluation component is further configured to auto-generate clinician notes by aggregating patient data and pre-existing evidenced-based treatment information.

10. The system according to claim 9, wherein the evaluation component is further configured to match a current patient with an existing patient having similar mood disorder characteristics, and present any notes for the existing patient as candidates for including in a current note.

11. The system according to claim 9, wherein the auto-generated clinician notes generated by the evaluation component are configured for editing by a user with permissions for editing the notes.

12. The system according to claim 4, wherein the evaluation component is further configured to generate a recommended course of patient treatment based on aggregated patient data identifying medical characteristics that exceed the predefined diagnostic threshold.

13. The system according to claim 12, wherein the evaluation component is configured to match a current patient with at least one existing patient having similar mood disorder characteristics, and identify treatment options for the at least one existing patient as candidate treatment options.

14. The system according to claim 12, wherein the evaluation component is further configured to generate a recommended course of patient treatment based on a formal diagnosis of a patient's condition.

15. The system according to claim 14, wherein the evaluation component is configured to match the formal diagnosis to at least one existing patient, and identify treatment options for the at least one existing patient as candidate treatment options.

16. A computer implemented method for capturing and analyzing medical information, the method comprising the acts of:
accepting, from a user interface, user responses to medical survey questions;
transforming, by a computer system, responses associated with a plurality of analysis metrics into a common scale;
evaluating, by the computer system, survey responses from the plurality of analysis metrics against a predefined diagnostic threshold, wherein the act of evaluating includes identifying any medical characteristics that exceed the diagnostic threshold; and
generating, by the computer system, a summary view for display on a host computer system including at least the medical characteristics that exceed the diagnostic threshold and the diagnostic threshold applied.

17. The method according to claim 16, wherein the medical survey questions are directed to assessing mood disorder information, and wherein the act of accepting includes an act of presenting to a host computer system questions directed to a plurality of mood disorder rating scales.

18. The method according to claim 17, wherein the act of transforming includes transforming survey responses into a common severity rating of a mood disorder symptom.

19. The method according to claim 17, wherein the diagnostic threshold is defined against criteria for establishing a formal clinical diagnosis of a mood disorder.

20. The method according to claim 18, wherein the act of generating a summary view further comprises displaying in graphical form the results of answered questions directed to a plurality of mood disorder rating scales.

21. The method according to claim 20, wherein the act of generating a summary view further comprises displaying in graphical form a visual indication highlighting diagnostic scores that exceed the diagnostic threshold.

22. The method according to claim 18, wherein the act of generating a summary view further comprises displaying in tabular form the results of answered questions directed to a plurality of mood disorder rating scales.

23. The method according to claim 16, wherein the act of evaluating survey responses further comprises auto-generating clinician notes by aggregating patient data and pre-existing evidenced-based treatment information.

24. The method according to claim 23, wherein auto-generating includes matching a current patient with an existing patient having similar mood disorder characteristics, and presenting any notes for the existing patient as candidates for including in a current note.

25. The method according to claim 23, wherein the auto-generating of notes further comprises providing functionality for manually editing the auto-generated notes by a user with appropriate permissions for editing.

26. The method according to claim 16, wherein the act of evaluating survey responses further comprises generating a recommended course of patient treatment based on aggregated patient data identifying medical characteristics that exceed the predefined threshold.

27. The method according to claim 17, wherein the act of evaluating survey responses further comprises generating a recommended diagnosis based on aggregated patient data identifying medical characteristics that exceed the predefined threshold.

28. The method according to claim 23, wherein the act of evaluating survey responses further comprises generating a recommended course of patient treatment based on a formal diagnosis of a patient's condition.
